(19) United States
(12) Patent Application Publication
(10) Pub. No.: US 2017/0060414 A1
(43) Pub. Date: Mar. 2, 2017

(54) DISPLAY INPUT DEVICE, IMAGE FORMING APPARATUS AND METHOD OF CONTROLLING DISPLAY INPUT DEVICE

(71) Applicant: KYOCERA Document Solutions Inc., Osaka (JP)

(72) Inventor: Kiyoshi HORI, Osaka (JP)

(73) Assignee: KYOCERA Document Solutions Inc., Osaka (JP)

(21) Appl. No.: 15/239,429

(22) Filed: Aug. 17, 2016

(30) Foreign Application Priority Data
Sep. 2, 2015 (JP) 2015-172896

(51) Int. Cl. G06F 3/0488; G06F 3/0489; G06F 3/0484; G06F 3/041

(52) U.S. Cl. CPC G06F 3/04886; G06F 3/0412; G06F 3/0416; G06F 3/04895; G06F 3/04845; H04N 2201/0094; H04N 1/00411

(57) ABSTRACT

A display input device includes a display panel, a touch panel and a control portion. The display panel displays a software keyboard screen including a plurality of symbol keys, a switching key between a normal input mode and a simple selection mode and an input display field where an input signal is displayed. The control portion recognizes, as a correction candidate symbol, a symbol corresponding to the symbol key in which an outer peripheral region in the region of the symbol key is operated, brings, when the mode is transferred to the simple selection mode, into a selected state, any one of the correction candidate symbols among the symbols displayed in the input display field and replaces, when a correction is made, the symbol with a symbol after being corrected.

This application is based upon and claims the benefit of priority from the corresponding Japanese Patent Application No. 2015-172896 filed on Sep. 2, 2015, the entire contents of which are incorporated herein by reference.

### BACKGROUND

The present disclosure relates to a display input device that receives an input of a symbol such as a character, a number or a mark. The present disclosure also relates to an image forming apparatus that includes such a display input device.

In a device which includes a display panel with a touch panel, a software keyboard may be used to perform inputs (data inputs) of various types of information. An example of an information terminal which displays a software keyboard as described below is known.

Specifically, an input device is known in which a plurality of operation items are displayed, when a touch panel is pressed down, the pressed-down position is detected, at least one of the operation items is determined to be an input item, a predetermined area including an operation item corresponding to the pressed-down position when the touch panel is pressed down is enlarged and displayed and when the pressing down of the touch panel is completed, an operation item in a position corresponding to the position that is finally pressed down is determined to be an input item.

In an image forming apparatus such as a multifunctional peripheral, a copying machine or a facsimile machine, an operation panel for settings is provided. On a display panel with a touch panel which is provided on the operation panel, a software keyboard may be displayed. A user operates the software keyboard to input a symbol such as a character, a number or a mark. In this way, it is possible to register information such as an address or a user name. In other types of devices such as a smartphone and a tablet terminal that have a touch panel, a software keyboard may be displayed so as to input a symbol.

In the software keyboard, symbols are sequentially input by a touch operation. In a software keyboard screen, a region in which the result of inputs (a symbol string which is input) is displayed is provided. The user sees the symbol string in the region to check whether or not there is an error on information which is input.

However, in the input to the software keyboard, attention is often focused on a keyboard portion. The region in which the result of inputs is displayed easily disappears out of sight. An operation on the software keyboard may be continuously performed without any notice of an operation on an erroneous symbol key (erroneous input). Then, after a plurality of symbols are input or after the final symbol is input, the operation mistake may be noticed.

In this case, the user moves a cursor (a position in which a symbol is input) or returns, with a back space key, to the symbol which is erroneously input so as to delete the erroneous symbol and thereafter inputs an appropriate symbol. In other words, the cursor movement key or the back space key is pressed long to return the input position of a symbol to the position in which the symbol is erroneously input. Then, the symbol is corrected. As the input position of the current symbol is farther away from the position in which the symbol is erroneously input, it takes more time to return the input position of the symbol.

Conventionally, in the software keyboard, the symbol which is erroneously input cannot be easily selected. Hence, disadvantageously, in the software keyboard, it takes a long time to correct some symbols which are input. During the correction, the correct symbol may be erroneously deleted. Hence, disadvantageously, in the input to the software keyboard, it is troublesome to correct a symbol.

Here, although in the known input device described above, an enlarged display is produced, it is not designed to make the user notice that an erroneous symbol key may be operated. It is also not designed to easily correct an erroneous symbol in a symbol string. Hence, with the known input device described above, it is impossible to solve the problem described above.

### SUMMARY

A display input device according to one aspect of the present disclosure includes a control portion, a display panel and a touch panel. The control portion includes a control circuit. The display panel displays, based on control by the control portion, a software keyboard screen including a plurality of symbol keys aligned for inputs of various types of symbols, a switching key for switching between a normal input mode and a simple selection mode and an input display field where a symbol corresponding to the symbol key that is operated is displayed. The touch panel is provided for the display panel so as to detect a position touched by a user. The control portion adds, in the normal input mode, each time the symbol key is operated, the symbol corresponding to the symbol key that is operated into the input display field, recognizes, when the symbol key is operated, as a correction candidate symbol, a symbol corresponding to the symbol key in which a predetermined outer peripheral region outside an inner region in the region of the symbol key is operated, transfers, when the switching key is operated in the normal input mode, the mode of the display input device to a simple selection mode, brings, when the mode is transferred to the simple selection mode, into a selected state, any one of the correction candidate symbols among the symbols displayed in the input display field and replaces, when the symbol in the selected state is corrected, the symbol in the selected state in the input display field with a symbol after being corrected.

Further features and advantages of the present disclosure will become apparent from the description of embodiments given below.

### BRIEF DESCRIPTION OF THE DRAWINGS

FIG. 1 is a diagram showing an example of a multifunctional peripheral according to an embodiment.

FIG. 2 is a diagram showing an example of an operation panel according to the embodiment.

FIG. 3 is a diagram showing an example of a software keyboard screen according to the embodiment.

FIG. 4 is a diagram showing an example of a user registration screen according to the embodiment.

FIG. 5 is a diagram showing an example of an address book registration screen according to the embodiment.

FIG. 6 is a diagram showing an example of a warning display in the software keyboard screen according to the embodiment.

FIG. 7 is a diagram showing an example of a region setting screen according to the embodiment.

FIG. 8 is a diagram showing an example of transfer to a simple selection mode according to the embodiment.

FIG. 9 is a diagram showing an example of the switching of symbols which are to be brought into a selected state in the simple selection mode according to the embodiment.

FIG. 10 is a diagram showing an example of the specification of a symbol in the simple selection mode according to the embodiment.

FIG. 11 is a diagram showing an example of the correction of a symbol on the operation panel according to the embodiment.

FIG. 12 is a diagram showing an example of the correction of a symbol on the operation panel according to the embodiment.

### DETAILED DESCRIPTION

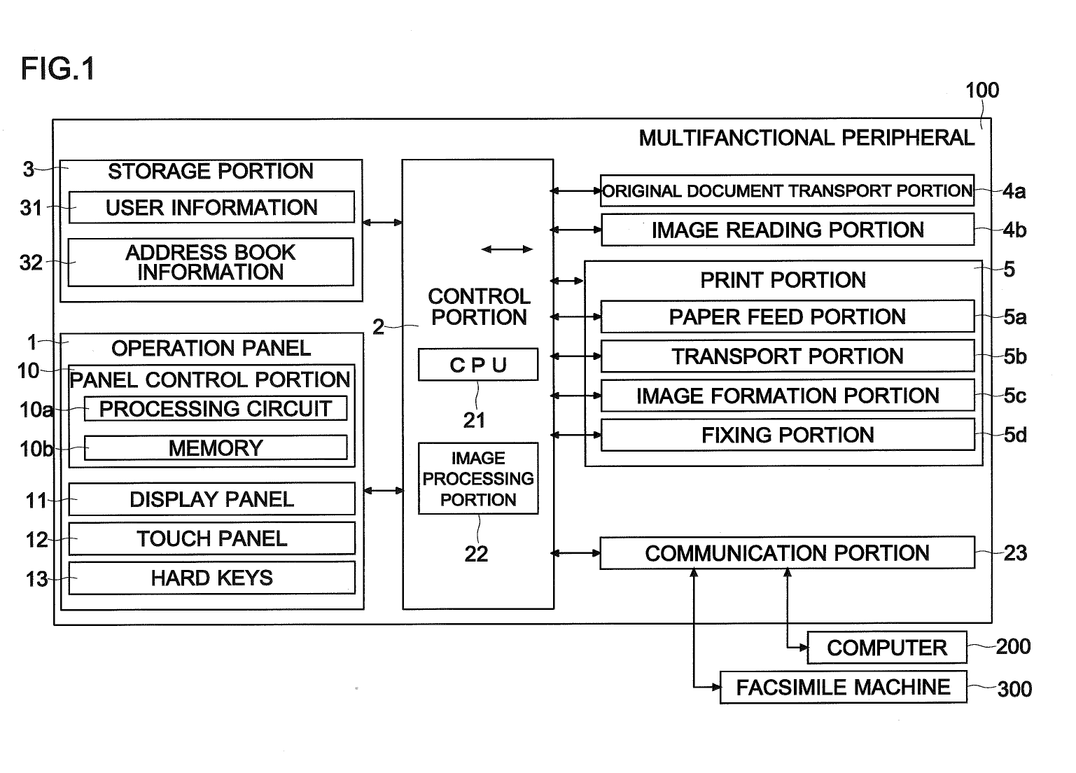

In the present disclosure, among symbols which are input, a symbol which is erroneously input is easily brought into a selected state, and thus the erroneously input symbol is easily corrected. Hence, an embodiment of the present disclosure will be described with reference to FIGS. 1 to 12. In the following description, a multifunctional peripheral 100 (which corresponds to an image forming apparatus) including an operation panel 1 (which corresponds to a display input device) will be used as an example. However, elements such as configurations and arrangements which will be described in the present embodiment do not limit the scope of the disclosure, and are simply an example of the description.

(Outline of Multifunctional Peripheral 100 and Operation Panel 1)

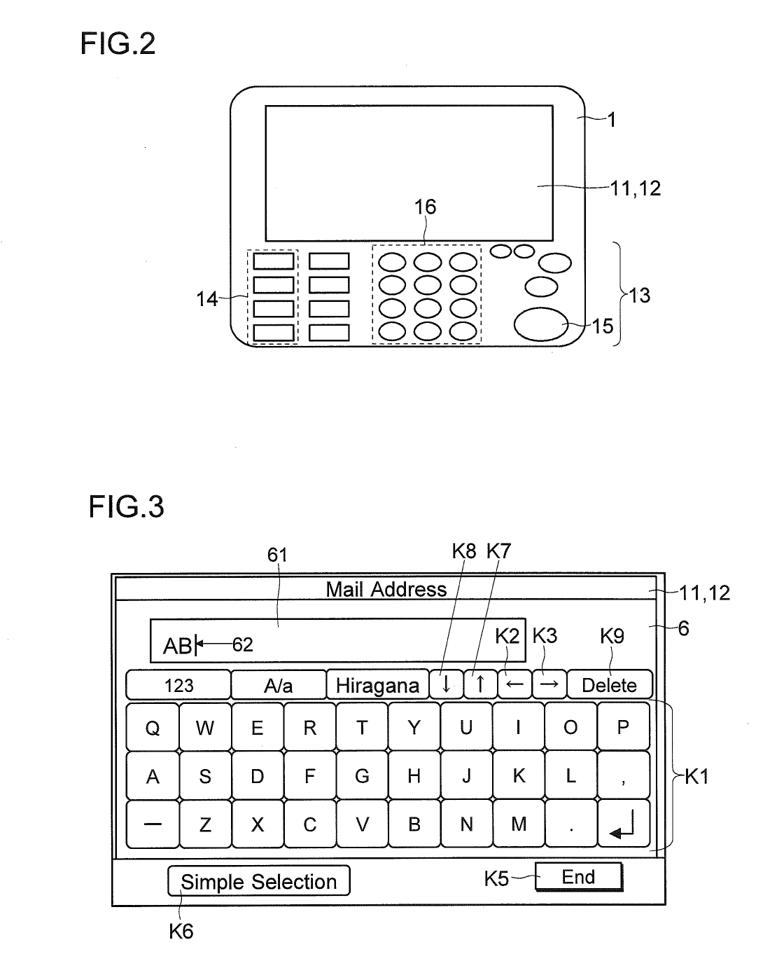

The multifunctional peripheral 100 and the operation panel 1 according to the embodiment will be described with reference to FIGS. 1 and 2.

The multifunctional peripheral 100 includes a main control portion 2 and a storage portion 3. The main control portion 2 includes circuits such as a CPU 21 and an image processing portion 22, and controls the operation of the multifunctional peripheral 100. The storage portion 3 is a combination between a nonvolatile storage device such as a ROM or a HDD and a volatile storage device such as a RAM. The storage portion 3 stores various types of control programs and various types of data such as setting data and image data. The CPU 21 performs control on the individual portions of the multifunctional peripheral 100 and various types of computation processing based on the programs and data stored in the storage portion 3. The image processing portion 22 performs processing and computation such as image processing on image data used for printing or transmission.

The multifunctional peripheral 100 includes the operation panel 1. The operation panel 1 is provided in an upper portion of the front surface of the multifunctional peripheral 100. The operation panel 1 includes a display panel 11 which displays information (states, various types of messages and various types of setting screens) on the multifunctional peripheral 100. On the upper surface of the display panel 11, a touch panel 12 is provided. The touch panel 12 is designed to detect a position touched by a user, and outputs a voltage (signal) corresponding to the detected position. On the operation panel 1, a plurality of hard keys 13 are also provided, such as a plurality of function keys 14 (see FIG. 2) for selecting the type of job to be performed, a start key 15 for an instruction to start the performance of a job and a numeric keypad 16 for an input of a number.

The operation panel 1 includes a panel control portion 10 (which corresponds to a control portion) which controls the display of the display panel 11. The panel control portion 10 is a substrate which includes a control circuit 10a such as a CPU and a memory 10b which stores data on the display and data on the control of the operation panel. The control circuit 10a is connected to the display panel 11 and the touch panel 12 to perform control on the display and the operation. Without provision of the panel control portion 10, the processing of the panel control portion 10 may be performed by the main control portion 2. In this case, the main control portion 2 functions as the control portion of the operation panel 1.

The panel control portion 10 recognizes, based on an output of the touch panel 12, a position pressed and its coordinates in the display panel 11 (touch panel 12), and recognizes an image (image such as a soft key, a button, a tab or a check box) which is operated. The panel control portion 10 is connected to the hard keys 13 to recognize the hard key 13 which is operated. Based on the recognition described above, the panel control portion 10 recognizes the details of a setting operation performed on the operation panel 1. The panel control portion 10 makes the display panel 11 switch displays according to an operation performed by the user on the touch panel 12 or the hard key 13. The panel control portion 10 reads data on a screen displayed on the display panel 11 from a memory (not shown) within the storage portion 3 or the operation panel 1. The panel control portion 10 notifies the details of the setting operation to the main control portion 2. The main control portion 2 controls the individual portions so as to satisfy the details of the setting operation by the user.

The multifunctional peripheral 100 includes an original document transport portion 4a and an image reading portion 4b. The original document transport portion 4a transports an original document set in a reading position. The image reading portion 4b reads the original document which is transported by the original document transport portion 4a or the original document which is set on a placement reading contact glass (not shown), and thereby generates image data. When a job such as for scanning, printing or transmission is performed, the main control portion 2 controls the operations of the original document transport portion 4a and the image reading portion 4b.

The multifunctional peripheral 100 includes a print portion 5. The print portion 5 includes a paper feed portion 5a, a transport portion 5b, an image formation portion 5c and a fixing portion 5d. When a job involving printing is performed, the paper feed portion 5a feeds sheets to the transport portion 5b one by one. The transport portion 5b transports the sheet supplied from the paper feed portion 5a. The image formation portion 5c forms a toner image based on image data, and transfers the toner image to the sheet transported. The fixing portion 5d fixes the toner image transferred to the sheet. The sheet to which the toner has been fixed is ejected to the outside of the machine.

The multifunctional peripheral 100 includes a communication portion 23. The communication portion 23 includes various types of connectors, sockets and a communication chip. The communication portion 23 is connected through a network or a cable to a computer 200 such as a PC or a server or to a facsimile machine 300 such that they can communicate with each other. The communication portion 23 receives data from the computer 200 or the facsimile machine 300 (reception function). Base on the data received by the communication portion 23, the main control portion 2 makes the print portion 5 perform printing (print job). The communication portion 23 also can transmit image data to the computer 200 or the facsimile machine 300 (transmission function).

(Input of Symbol on Operation Panel 1)

An example of the input of a symbol on the operation panel 1 (the display input device) according to the embodiment will then be described with reference to FIGS. 3 to 5.

On the operation panel 1, symbols such as a character, a number and a mark can be input. In other words, the letters of the alphabet can be input as symbols. Since the operation panel deals with Japanese, kanji and kana characters can be input. On the operation panel, numbers and marks such as an at sign, a period and a comma can also be input as symbols. For information on users and information on addresses, a plurality of symbols (symbol string) are input.

The panel control portion 10 controls the display panel 11, and displays a software keyboard screen 6 on the display panel 11 when a symbol is input (see FIG. 3). In the software keyboard screen 6, a plurality of symbol keys K1 are arranged. An input display field 61 in which the result of inputs is displayed is also provided. FIG. 3 shows a state where a plurality of symbol keys K1 are placed in parallel (arranged). One letter of the alphabet corresponds to one symbol key K1, and it is possible to input the letters of the alphabet. With a predetermined operation, it is also possible to display symbol keys K1 corresponding to various types of marks and numbers.

The user repeatedly operates (touches display positions) symbol keys K1 in the software keyboard screen 6 in such an order as to produce a desired symbol string (character string). The panel control portion 10 recognizes, based on outputs of the touch panel 12, the symbol keys K1 which are operated. The panel control portion 10 displays the result of inputs (the result of operations) by the user in the input display field 61. Specifically, the panel control portion 10 displays, on the display panel 11, the symbols corresponding to the symbol keys K1 operated in the order in which the symbol keys K1 are operated. FIG. 3 shows an example of the state where the user operates the symbol key K1 of “A” and then operates the symbol key K1 of “B” (where the user touches the display positions).

In the input display field 61, a cursor 62 is displayed. The cursor 62 indicates a position into which a symbol is inserted when the symbol key K1 is operated, and is a blinking vertical line. As the number of input symbols is increased, the panel control portion 10 moves the position of the cursor 62 to the right side. In the software keyboard screen 6, a leftward direction key K2 and a rightward direction key K3 are provided. When the leftward direction key K2 is operated once, the panel control portion 10 moves the position of the cursor 62 leftward by one position. When the rightward direction key K3 is operated once, the panel control portion 10 moves the position of the cursor 62 rightward by one position.

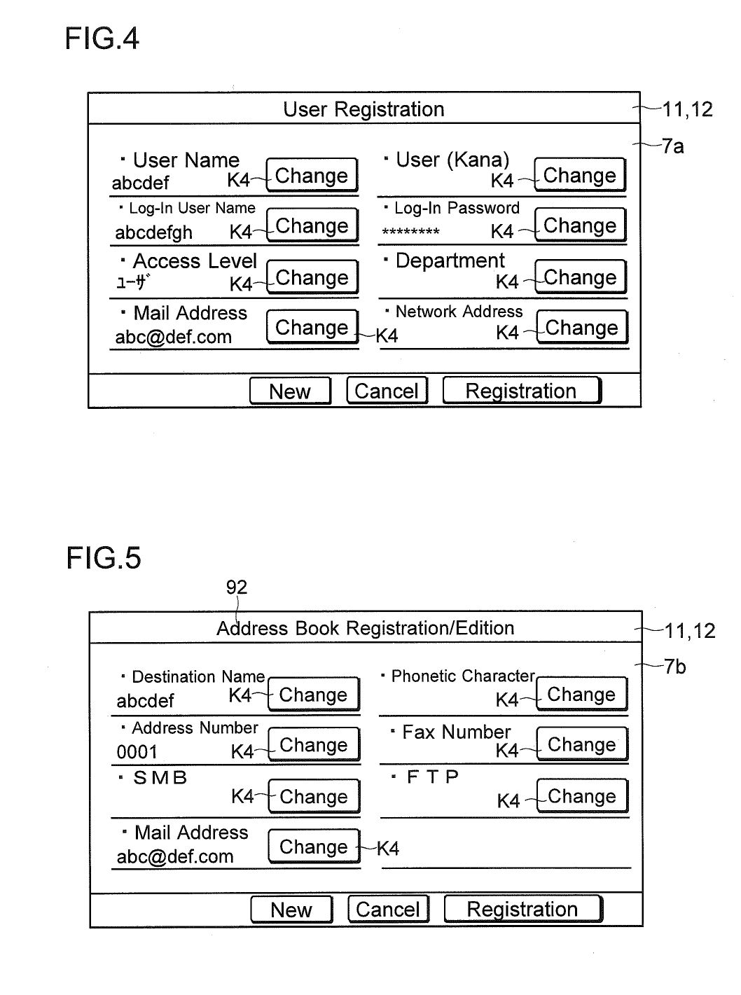

In order to provide the authority to use the multifunctional peripheral 100 or to transmit image data obtained by reading to the computer 200 in a corporate network, it is necessary to have information on the user. In the multifunctional peripheral 100 (the operation panel 1), symbols are input, and thus it is possible to register the information on the user. FIG. 4 is a user registration screen 7a for registering the information on the user. In the user registration screen 7a, it is possible to register a plurality of items on user information 31 such as a user name and an e-mail address.

It is troublesome to input an address such as an e-mail address, a network address or a fax number each time data such as image data is transmitted to the outside. Hence, in the multifunctional peripheral 100 (the operation panel 1), information on transmission destinations can be registered in an address book. FIG. 5 is an address book registration screen 7b for registering the information on the transmission destinations. In the address book registration screen 7b, a plurality of items such as a destination name and various types of addresses can be registered (see FIG. 5). When information on the destinations is registered, an address or a party to which to perform transmission is only selected, and thus it is possible to complete the setting of the transmission destination. For a purpose other than the user registration and the address book, a screen in which symbols (information) are input may be provided.

When a predetermined operation is performed on the operation panel, the panel control portion 10 displays the user registration screen 7a or the address book registration screen 7b on the display panel 11. Then, in the user registration screen 7a and the address book registration screen 7b, the names of items in which symbols such as a user name, a password, an address, a pass and a fax number are input are displayed. The panel control portion 10 displays already registered information (symbol string) below each of the items (see FIGS. 4 and 5).

For one input item, one change key K4 is provided. The user operates the change key K4 corresponding to an item which is newly registered or is changed (touches the display position). For example, when it is desired to set an e-mail address, the change key K4 corresponding to the e-mail address is operated. When the change key K4 is operated, the panel control portion 10 displays the software keyboard screen 6 (see FIG. 3) on the display panel 11. In this way, it is possible to input information on the selected item. The panel control portion 10 notifies the main control portion 2 of the details of the input display field 61 when a completion key K5 is operated in the software keyboard screen 6. The main control portion 2 stores the received details, in the storage portion 3, as data (the user information 31 or address book information 32) corresponding to the symbol input item.

(Outline of Warning Display)

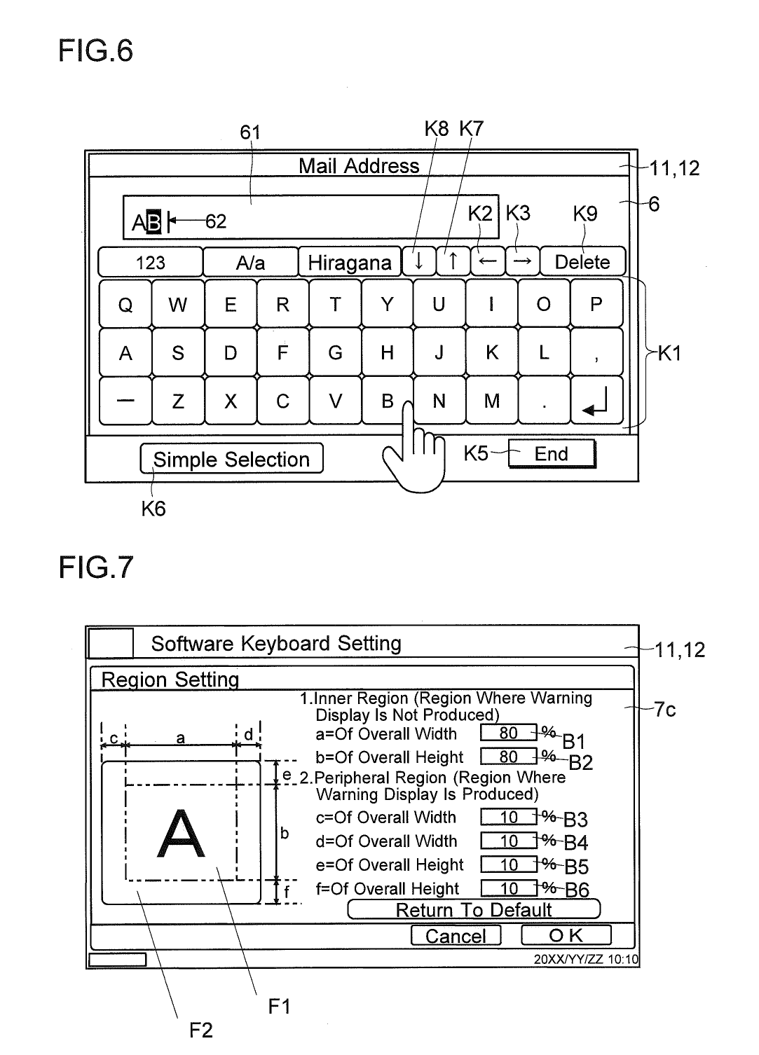

A warning display in the display input device 1 according to the embodiment will then be described with reference to FIGS. 6 and 7.

When information such as a pass, an e-mail address or a fax number is input, the symbol keys K1 are operated such that the same symbol string as the information to be input (correct data) is displayed in the input display field 61. However, even though the user believes that the correct symbol keys K1 are touched, the user may erroneously operate the symbol keys K1. Then, the user continues to operate the symbol keys K1 (touch the display positions) without being aware of the error.

In such a case, it is likely that all the symbols up to the erroneous position are deleted with the back space key and are corrected, and that thereafter an input needs to be performed again. With the direction key, the position of the cursor 62 is moved to the position of the symbol which is erroneously input, the symbol which is erroneously input is deleted and then the correct symbol is inserted into an appropriate position. In the correction operation, the back space key and the direction key need to be used to return the position of the cursor 62 when the input is thought to be completed to the position of the symbol which is erroneously input. The user feels that this is troublesome. When an erroneous input can be noticed at the time of the occurrence of the erroneous input, it is possible to immediately correct a mistake, and it is also easy to correct it.

Hence, the panel control portion 10 determines whether or not an erroneous input may be produced. The panel control portion 10 recognizes, as a correction candidate symbol 8, a symbol which may be erroneously input. The panel control portion 10 displays, among the symbols in the input display field 61, the correction candidate symbol 8 in a warning state which is different from a normal display.

The panel control portion 10 uses the position of the symbol key K1 which is touched, and thereby determines whether or not an erroneous input may be produced. Specifically, the panel control portion 10 determines, by whether the touched position belongs to an inner region F1 of the symbol key K1 or to an outer peripheral region F2, whether or not an erroneous input may be produced.

Here, the inner region F1 is a region which includes a center of a display region in the display region of the symbol key K1 and which has a predetermined size. The outer peripheral region F2 is an outer region (surrounding region) which surrounds the inner region F1 in the display region of the symbol key K1. The panel control portion 10 recognizes, based on the output of the touch panel 12, the symbol key K1 which is operated, and recognizes, based on the coordinates of the touched position which is detected, to which one of the inner region F1 and the outer peripheral region F2 the touched potion belongs.

When the inner region F1 is touched, the panel control portion 10 normally displays, in the input display field 61, the symbol corresponding to the symbol key K1 which is operated. In the normal display, the panel control portion 10 displays a symbol in a color such as black which is determined to be used for the normal display, particularly without enhancement and modification on the display.

On the other hand, when the outer peripheral region F2 is touched, the panel control portion 10 recognizes, as the correction candidate symbol 8, the symbol corresponding to the symbol key K1 which is operated. Then, the panel control portion 10 produces, as the warning display, the correction candidate symbol 8 in the input display field 61. FIG. 6 shows an example of the warning display. The background of the input display field 61 in the software keyboard screen 6 in FIG. 6 is white. In FIG. 6, the correction candidate symbol 8 is “B”. The panel control portion 10 displays the correction candidate symbol 8 of “B” in a character color for enhancement, such red, which is previously determined. The panel control portion 10 displays the correction candidate symbol 8 of “B” in highlight (background color additional display).

As described above, the panel control portion 10 displays, on the display panel 11, the correction candidate symbol 8 in a state which is different from the normal display (black on white background, the symbol of “A” in FIG. 6). The correction candidate symbol 8 may be blinked. As described above, the panel control portion 10 changes the display color of the symbol corresponding to the symbol key K1 whose outer peripheral region F2 is operated, displays it in highlight and thereby produces the warning display.

A selling screen for the region of the symbol key K1 is provided. FIG. 7 is a diagram showing an example of a region setting screen 7c. When a predetermined operation is performed on the operation panel 1, the panel control portion 10 displays the region setting screen 7c on the display panel 11. The region setting screen 7c is a screen for determining the sizes of the inner region F1 and the outer peripheral region F2 in the symbol key K1.

In the region selling screen 7c, two numeric input fields B1 and B2 for determining the size of the inner region F1 and four numeric input fields B3, B4, B5 and B6 for determining the size of the outer peripheral region F2 are arranged. The display regions of the numeric input fields are touched and the numeric keypad 16 (see FIG. 2) is operated, and thus it is possible to determine the individual values of a to f. When the display regions of the numeric input fields B1 to B6 are touched, the panel control portion 10 may display, on the display panel 11, the software keyboard screen 6 for the numeric input to determine the sizes of the inner region F1 and the outer peripheral region F2 by providing inputs to the software keyboard screen 6.

For the lateral direction of the symbol key K1, the ratio (the value of “a” in FIG. 7) of the width of the inner region F1 to the width of the symbol key K1, the ratio (the value of “c” in FIG. 7) of the width of the outer peripheral region F2 on the left side to the width of the symbol key K1 and the ratio (the value of “d” in FIG. 7) of the width of the outer peripheral region F2 on the right side to the width of the symbol key K1 can be determined. The total of the values of “a”, “c” and “d” is 100%.

On the other hand, for the vertical direction of the symbol key K1, the ratio (the value of “b” in FIG. 7) of the vertical width of the inner region F1 to the vertical width of the symbol key K1, the ratio (the value of “e” in FIG. 7) of the width of the outer peripheral region F2 on the upper side to the vertical width of the symbol key K1 and the ratio (the value of “f” in FIG. 7) of the width of the outer peripheral region F2 on the lower side to the width of the symbol key K1 can be determined. The total of the values of “b”, “e” and “f” is 100%.

Settings can be made as follows. It is assumed that the values of “a” and “b” for the inner region F1 are 0, that “c”+“d”=100% and that “e”+“f”=100%, with the result that when the symbol key K1 is operated, a warning display is produced without fail.

As described above, the control portion 5 displays, on the display panel 11, the region setting screen 7c for setting the sizes of the inner region F1 and the outer peripheral region F2. Then, based on the sizes of the regions set in the region setting screen 7c, the control portion 5 recognizes whether or not the touched position is the inner region F1 or the outer peripheral region F2.

(Simple Selection Mode)

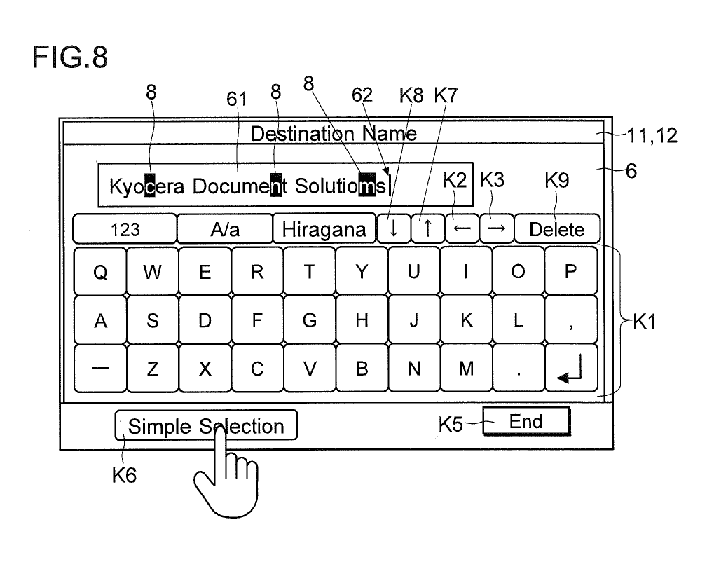

A simple selection mode in the display input device 1 according to the embodiment will then be described with reference to FIGS. 8 to 10.

An example where the software keyboard screen 6 is opened for registering the item of the “destination name” in the address book will be described below. However, the following description is likewise applied to the software keyboard screen 6 which is displayed for registering information on the other items.

The simple selection mode is a mode in which among the symbols in the input display field 61, a symbol to be corrected is easily selected. In order to transfer from a normal input mode to the simple selection mode, a switching key K6 is provided in the software keyboard screen 6. The normal input mode is a normal mode in which a symbol is input. In the normal input mode, each time the symbol key K1 is operated, the panel control portion 10 adds, into the input display field 61, the symbol corresponding to the symbol key K1 which is operated. In other words, in the normal input mode, when the user operates the symbol keys K1, symbols are sequentially input to the input display field 61.

As shown in FIG. 8, when the switching key K6 is operated in the normal input mode, the panel control portion 10 sets the mode of the operation panel 1 (the display input device) to the simple selection mode. In the simple selection mode, the switching key K6 is displayed by black-and-white reversal so that the simple selection mode is indicated. In the normal input mode, the switching key K6 is displayed normally (the background color of the switching key K6 is white and the character inside the switching key K6 is black). As described above, the panel control portion 10 switches the display states of the switching key K6 depending whether the mode is the normal input mode or the simple selection mode. By another display form, whether the mode is the normal input mode or the simple selection mode may be indicated.

FIG. 8 shows a state where the display input device is in the normal input mode and where a symbol string of “Kyocera Document Solutioms” is input by the user. In the symbol string which is input, the panel control portion 10 recognizes, as the correction candidate symbols 8, “c” of “Kyocera”, “n” of “Document” and “m” of “Solutioms”, and displays them in the warning state.

Here, in the symbol string of “Kyocera Document Solutioms”, the symbol which is actually erroneously input is “m” of “Solutioms”. The correct symbol is “n (Solutions)” (the same is true for the following description).

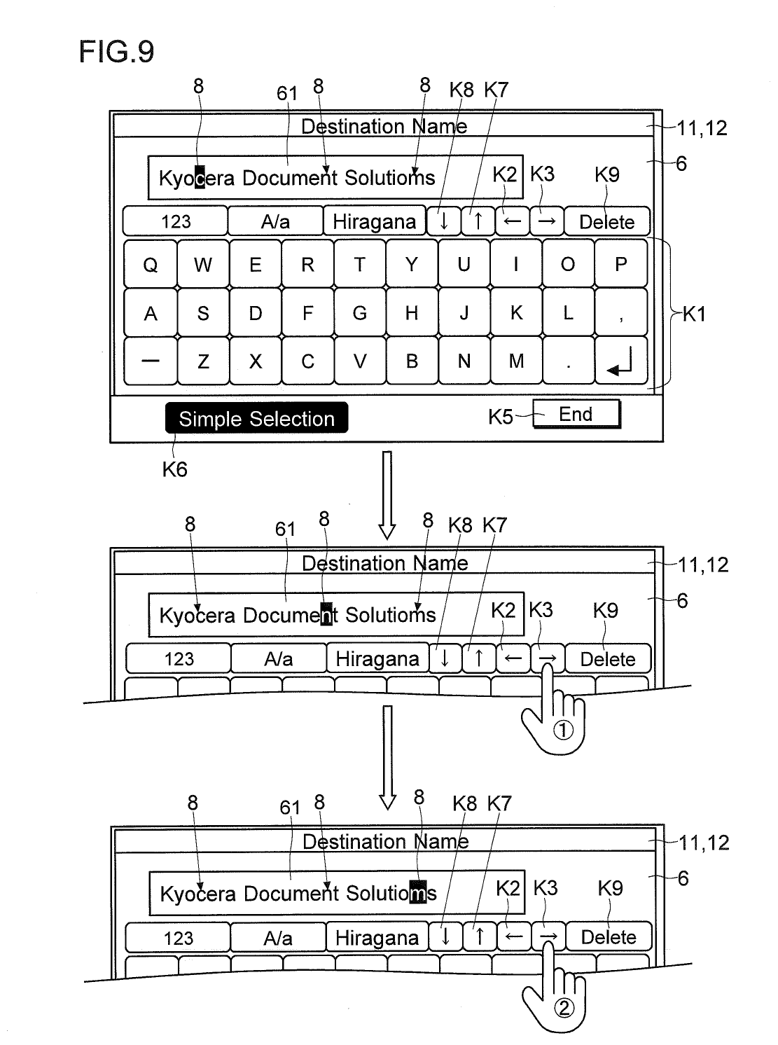

When the correction candidate symbols 8 are included in the character string in the input display field 61, and the mode is transferred to the simple selection mode, the panel control portion 10 brings, into a selected state, any one of the correction candidate symbols 8 among the symbols displayed in the input display field 61. The figure in the uppermost stage of FIG. 9 shows an example where when the mode is transferred to the simple selection mode, the panel control portion 10 brings, into the selected state, “c” among the symbols which are recognized to be the correction candidate symbols 8 in the input display field 61.

In other words, when a plurality of correction candidate symbols 8 are included in the input display field 61, and the mode is transferred to the simple selection mode, the panel control portion 10 first brings, into the selected state, the correction candidate symbol 8 located at the head. When the mode is transferred to the simple selection mode, the panel control portion 10 may bring, into the selected state, a correction candidate symbol 8 other than the correction candidate symbol 8 at the head. When no correction candidate symbol 8 is present among the symbols in the input display field 61, and the mode is transferred to the simple selection mode, the panel control portion 10 does not bring any symbol into the selected state.

The panel control portion 10 displays, by black-and-white reversal, on the display panel 11, the symbol in the selected state (the same state as the warning display may be adopted). The panel control portion 10 produces a difference in display between the symbol in the selected state and the symbols which are not selected. However, the method of indicating the selected state is not limited to the black-and-white reversal. The symbol in the selected state may be displayed by a method in which the symbol is changed to a white-solid symbol, the color of the symbol is changed, the size of the symbol is changed, the symbol is italicized or the symbol is boldfaced. When any one of the symbols in the input display field 61 is brought into the selected state, the position to which a symbol is input is set to the position of the symbol in the selected state, and the panel control portion 10 stops the display of the cursor 62.

Here, in the example shown in FIGS. 8 and 9, a plurality of symbols (correction candidate symbols 8) which are recognized by the panel control portion 10 to be possibly erroneously input are included in the symbol string in the input display field 61. Then, the symbol (erroneously input symbol) which actually needs to be corrected is “m” of “Solutioms”. In order to make a correction, it is necessary to bring “m” into the selected state. On the other hand, in the example shown in FIGS. 8 and 9, “m” is the correction candidate symbol 8 but is not located at the head. As described above, among the symbols in the input display field 61, the erroneously input symbol may not be located at the head of a plurality of correction candidate symbols 8.

Each time the direction key is operated, the panel control portion 10 switches the correction candidate symbols 8 which are to be brought into the selected state such that even in such a case, the erroneously input symbol can easily be selected. In the software keyboard screen 6 of the present embodiment, in a position which is on the right side of the input display field 61 and which is below the input display field 61, four types of direction keys that are an upward direction key K7, a downward direction key K8, the leftward direction key K2 and the rightward direction key K3 are provided.

Each time the rightward direction key K3 or the leftward direction key K2 is operated, the panel control portion 10 switches the correction candidate symbols 8 which are to be brought into the selected state. The figure in the middle stage of FIG. 9 shows an example where after the mode is transferred to the simple selection mode, the rightward direction key K3 is operated once, and thus the panel control portion 10 switches the selected state from “c” to “n” which is the correction candidate symbol 8 adjacent in the rightward direction thereto. The figure in the lowermost stage of FIG. 9 shows an example where the rightward direction key K3 is operated twice (operated one more time), and thus the panel control portion 10 switches the selected state from “n” to “m” which is the correction candidate symbol 8 further adjacent in the rightward direction thereto. In other words, the user operates, among the direction keys, the direction key corresponding to the direction toward the symbol which is to be brought into the selected state once or a plurality of times.

When the rightward direction key K3 is operated so as to bring, into the selected state, the correction candidate symbol 8 located on the right side, the panel control portion 10 brings, into the selected state, the correction candidate symbol 8 which is adjacent in the rightward direction to the correction candidate symbol 8 that is brought into the selected state before the operation of the rightward direction key K3. When the leftward direction key K2 is operated so as to bring, into the selected state, the correction candidate symbol 8 located on the left side, the panel control portion 10 brings, into the selected state, the correction candidate symbol 8 which is adjacent in the leftward direction to the correction candidate symbol 8 that is brought into the selected state before the operation of the leftward direction key K2.

As described above, without returning the position of the cursor 62, it is possible to easily bring, into the selected state, the symbol which is recognized by the panel control portion 10 to be possibly erroneously input. Hence, it is possible to easily select the erroneously input symbol. It is possible to easily correct the erroneously input character (the details of the correction will be described later).

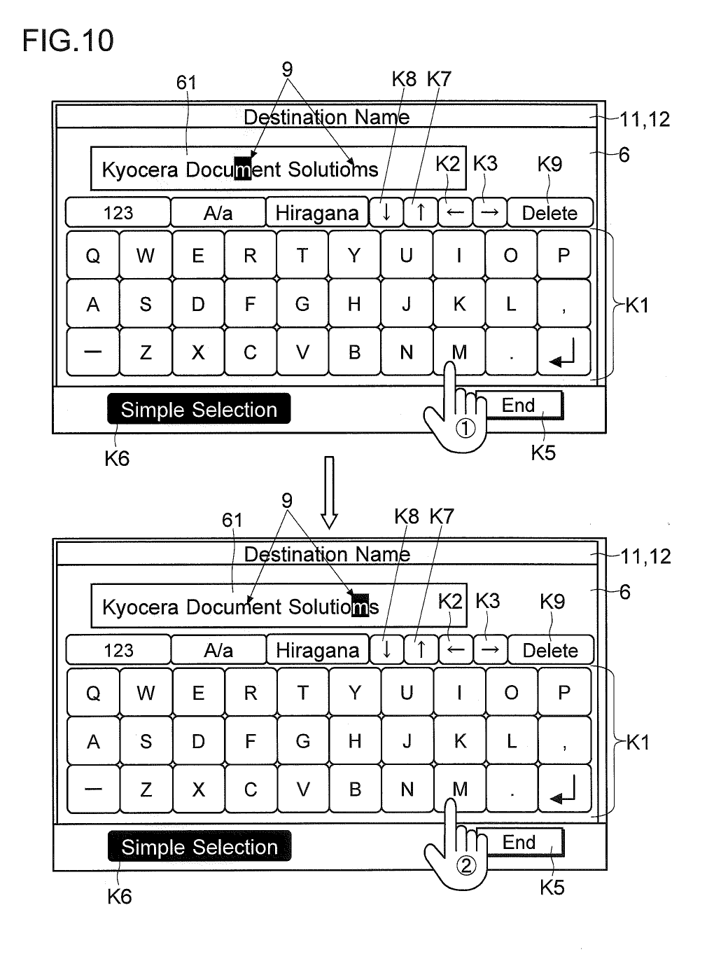

In the simple selection mode, the symbol key K1 is operated, and thus it is possible to specify a character to be corrected among the symbols in the input display field 61. In other words, the symbol key K1 is operated, and thus it is possible to bring a specific symbol into the selected state. The specification of the symbol will be described with reference to FIG. 10.

In the simple selection mode, the panel control portion 10 first recognizes, as a specified symbol 9, the symbol corresponding to the symbol key K1 which is operated. FIG. 10 shows an example where since the symbol key K1 corresponding to the symbol of “m” is operated, the panel control portion 10 recognizes the symbol of “m” as the specified symbol 9.

When in the simple selection mode, any one of the symbol keys K1 is operated, the panel control portion 10 brings, into the selected state, any one of the symbols which are in the input display field 61 and which are the same as the specified symbol 9 that is recognized. The figure in the upper portion of FIG. 10 shows an example where since the symbol key K1 corresponding to the symbol of “m” is operated, the panel control portion 10 brings, into the selected state, the specified symbol 9 of “m” at the head of “Document” in the input display field 61.

As described above, when in the simple selection mode, the specified symbol 9 is recognized, and a plurality of symbols which are the same as the specified symbol 9 are included in the input display field 61, the panel control portion 10 brings, into the selected state, the symbol located at the head of the same symbols as the specified symbol 9.

However, the symbol (erroneously input symbol) which actually needs to be corrected is “m” of “Solutioms”. Hence, when the same symbol key K1 is operated, the panel control portion 10 switches the specified symbols 9 which are to be brought into the selected state. The figure in the lower portion of FIG. 10 shows a state where the symbol key K1 corresponding to the symbol of “m” is operated once, and thereafter the symbol key K1 corresponding to the symbol of “m” is operated again. In other words, the figure in the lower portion of FIG. 10 shows an example where since the symbol key K1 corresponding to the specified symbol 9 is repeatedly operated, the panel control portion 10 switches the symbol in the selected state to “m” of “Solutioms” among the symbols in the input display field 61.

As described above, in the simple selection mode, when a plurality of symbols which are desired to be specified are included in the input display field 61, the panel control portion 10 switches the specified symbols 9 which are to be brought into the selected state each time the symbol key K1 corresponding to the specified symbol 9 is operated. In this way, the user can bring, into the selected state, the symbol which is to be corrected simply by operating, once or a plurality of times, the symbol key K1 corresponding to the symbol which is to be corrected.

(Correction of Symbol)

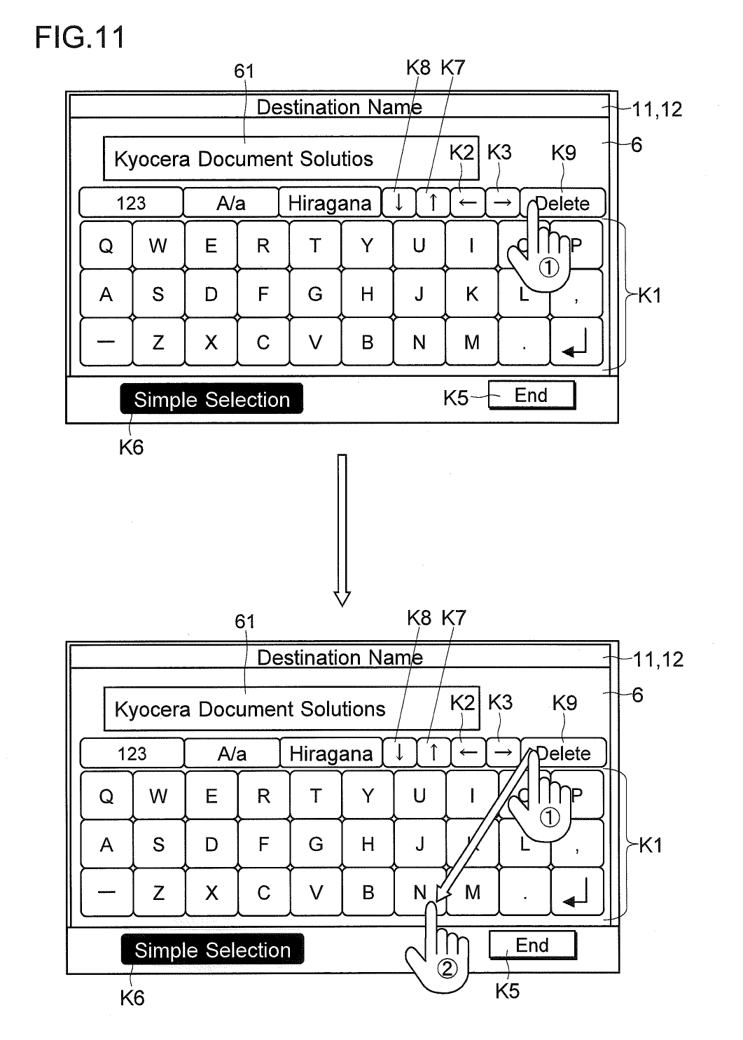

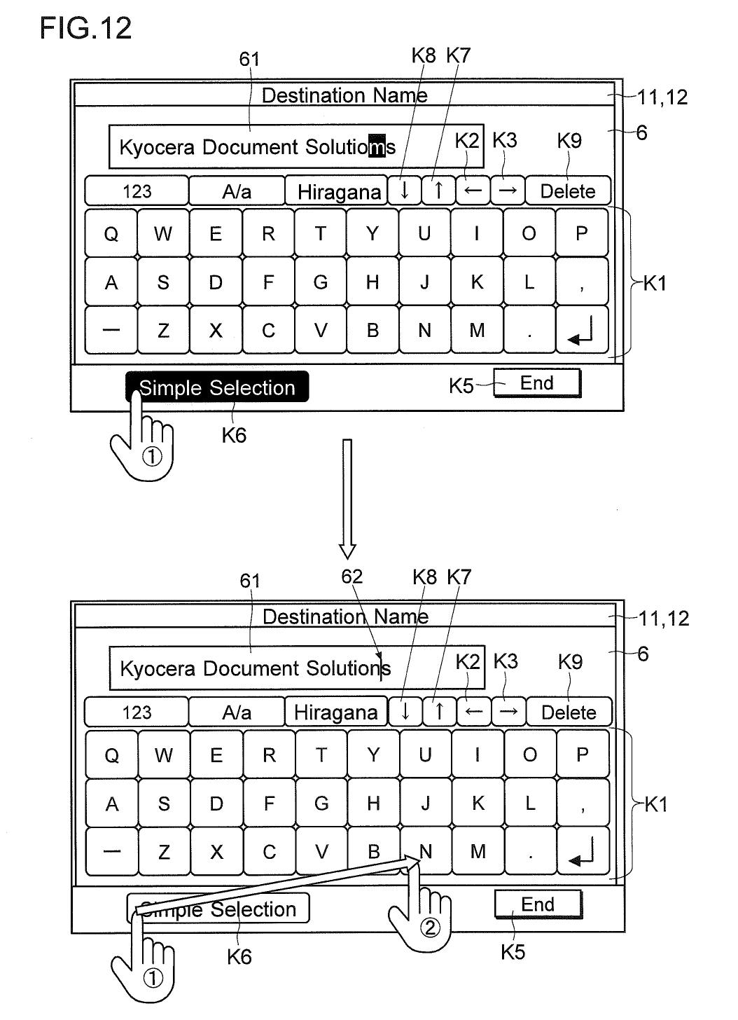

The correction of a symbol on the operation panel 1 according to the embodiment will then be described with reference to FIGS. 11 and 12. FIGS. 11 and 12 are diagrams showing an example of the correction of a symbol on the operation panel 1 according to the embodiment.

As described above, on the operation panel 1 (the display input device) according to the embodiment, the erroneously input symbol can easily be brought into the selected state. Then, the operation panel 1 receives an input for correcting the symbol in the selected state. An example of the flow of the correction of the symbol will be described below.

The panel control portion 10 first displays, on the display panel 11, a deletion key K9 used for correcting the symbol in the software keyboard screen 6.

The panel control portion 10 receives, as an input for deleting the symbol in the selected state, the operation of the deletion key K9 in a state where any one of the symbols in the input display field 61 is selected. Then, the panel control portion 10 receives, as the symbol after being corrected, a symbol corresponding to the symbol key K1 which is subsequently operated after the deletion key K9. In this case, the panel control portion 10 does not recognize the operation of the symbol key K1 as the operation for specifying a symbol.

Consequently, the panel control portion 10 inserts the symbol after being corrected into the position of the deleted symbol. In other words, in the simple selection mode, the panel control portion 10 replaces the symbol in the selected state in the input display field 61 with the symbol corresponding to the symbol key K1 which is subsequently operated after the operation of the deletion key K9.

FIG. 11 shows the flow of the correction of a symbol in the simple selection mode. The figure in the upper stage of FIG. 11 shows a state where the user operates the deletion key K9 with “m” of “Solutioms” in the selected state. The figure in the lower stage of FIG. 11 shows a state where the user subsequently operates the symbol key K1 of “n” after the deletion key K9 to insert the correct symbol of “n” after being corrected into the position of the deleted symbol.

After the switching correction is performed by the operation of the symbol key K1, when the symbol key K1 is subsequently operated, the symbol corresponding to the symbol key K1 which is operated in the input display field 61 is brought into the selected state (if no operation is performed, no change is made).

The correction of a symbol in the normal input mode after return from the simple selection mode to the normal input mode will then be described with reference to FIG. 12.

The panel control portion 10 first returns the mode of the display panel 11 to the normal input mode when the switching key K6 is operated in the simple selection mode. When only one symbol is erroneously input, it is not necessary to bring another symbol into the selected state. Hence, in this case, the erroneously input symbol is preferably corrected after return to the normal input mode.

The figure in the upper stage of FIG. 12 shows that the switching key K6 is operated so as to return to the normal input mode. The simple selection mode is cancelled, and consequently, the panel control portion 10 returns the operation panel 1 to the normal input mode. As shown in the figure in the lower stage of FIG. 12, in order to show that the operation panel 1 is returned to the normal input mode, the panel control portion 10 displays, on the display panel 11, the switching key K6 in the state of black-and-white non-reversal.

When after the normal input mode is temporarily transferred to the simple selection mode, the simple selection mode is returned to the normal input mode, the panel control portion 10 may or may not display, in the warning state, the correction candidate symbol 8 which is not corrected. FIG. 12 shows an example where when the simple selection mode is returned to the normal input mode, the panel control portion 10 cancels the warning display of the correction candidate symbol 8.

Even when the simple selection mode is returned to the normal input mode, the symbol in the input display field 61 is maintained in the selected state. The figure in the lower stage of FIG. 12 shows a state where the user subsequently operates the symbol key K1 of “n” after the switching key K6 and thereby replaces “m” of “Solutioms” in the selected state with the correct symbol (the symbol after being corrected) of “n”. Then, the panel control portion 10 restarts the display of the cursor 62.

In this way, the display input device (the operation panel 1) according to the embodiment includes: the display panel 11 which displays the software keyboard screen 6 including a plurality of symbol keys K1 aligned for inputs of various types of symbols, the switching key K6 for switching between the normal input mode and the simple selection mode and the input display field 61 where a symbol corresponding to the symbol key K1 that is operated is displayed; the touch panel 12 which is provided for the display panel 11 so as to detect a position touched by the user; and the control portion (the panel control portion 10) which adds, in the normal input mode, each time the symbol key K1 is operated, the symbol corresponding to the symbol key K1 that is operated into the input display field 61, which recognizes, as the correction candidate symbol 8, a symbol corresponding to the symbol key K1 in which the predetermined outer peripheral region F2 outside the inner region F1 in the region of the symbol key K1 is operated, which transfers, when the switching key K6 is operated in the normal input mode, the mode of the display input device to the simple selection mode, which brings, when the mode is transferred to the simple selection mode, into the selected state, any one of the correction candidate symbols 8 among the symbols displayed in the input display field 61 and which replaces, when the symbol in the selected state is corrected, the symbol in the selected state in the input display field 61 with the symbol after being corrected.

When the outer peripheral region F2 of the symbol key K1 is operated, the symbol key K1 next to the symbol key K1 which is originally desired to be operated may be erroneously operated. In other words, an erroneous input may be produced. A person who has thick fingers is more likely to touch the symbol key K1 next to the symbol key K1 which is originally desired to be touched. Hence, when the mode is transferred to the simple selection mode, the control portion (the panel control portion 10) brings, into the selected state, any one of the correction candidate symbols 8 among the symbols displayed in the input display field 61. In this way, the symbol (the symbol which is highly likely to be erroneously input) corresponding to the symbol key K1 whose outer peripheral region F2 is operated is automatically brought into the selected state. Simply by transferring to the simple selection mode, the position in which the symbol is input is automatically jumped to the position of the symbol which is highly likely to be erroneously input. When the symbol which is automatically brought into the selected state is an erroneously input symbol, it is possible to immediately correct the symbol. Unlike a conventional method, it is not necessary to repeatedly operate or press long a movement key in the position in which the symbol is input. It is possible to easily bring the erroneously input symbol into the selected state and to correct it. Hence, it is possible to easily correct the erroneously input symbol, and thus it is possible to enhance the ease of use of the software keyboard.

The display panel 11 also displays the direction keys in the software keyboard screen 6. When in the simple selection mode, a plurality of correction candidate symbols 8 are included in the input display field 61, the control portion (the panel control portion 10) brings, when the mode is transferred to the simple selection mode, the correction candidate symbol 8 located at the head into the selected state, and switches the correction candidate symbols 8 which are to be brought into the selected state. In this way, when a plurality of symbol keys K1 whose outer peripheral region F2 is operated are present, simply by operating the direction key, it is possible to sequentially switch the correction candidate symbols 8 which are to be brought into the selected state. In other words, it is possible to jump the input position to the position of the symbol which is highly likely to be erroneously input without repeatedly operating or pressing long the movement key. Hence, it is possible to more easily correct the erroneously input symbol.

The display panel 11 displays the rightward direction key K3 and the leftward direction key K2 in the software keyboard screen 6. When the rightward direction key K3 is operated, the control portion (the panel control portion 10) brings, into the selected state, the correction candidate symbol 8 adjacent in the rightward direction to the correction candidate symbol 8 that is brought into the selected state before the operation of the rightward direction key K3 whereas when the leftward direction key K2 is operated, the control portion (the panel control portion 10) brings, into the selected state, the correction candidate symbol 8 adjacent in the leftward direction to the correction candidate symbol 8 that is brought into the selected state before the operation of the leftward direction key K2. In this way, the position in which the symbol is input can be jumped in the intended direction (freely).

In the simple selection mode, the control portion (the panel control portion 10) recognizes, as the specified symbol 9, the symbol corresponding to the symbol key K1 which is operated, and brings, when any one of the symbol keys K1 is operated, into the selected state, any one of the specified symbols 9 among the symbols in the input display field 61. In this way, simply by operating the symbol key K1 (the same symbol key K1 as the symbol key K1 which is previously erroneously input) corresponding to the erroneously input symbol, it is possible to select the erroneously input symbol among the symbols in the input display field 61 and to immediately correct it. Unlike the conventional method, it is possible to correct the erroneously input symbol without repeatedly operating or pressing long the movement key. Hence, it is possible to easily correct the erroneously input symbol. It is also possible to significantly enhance the ease of use of the software keyboard (the ease of the correction).

When in the simple selection mode, a plurality of specified symbols 9 are included in the input display field 61, each time the symbol key K1 corresponding to the specified symbol 9 is operated, the control portion (the panel control portion 10) switches the specified symbols 9 which are to be brought into the selected state. In this way, when a plurality of specified symbols 9 are included in the input display field 61, simply by repeatedly operating the symbol key K1 corresponding to the specified symbol 9, it is possible to switch the symbols which are to be brought into the selected state. In this way, it is possible to bring, into the selected state, the intended specified symbol 9 among a plurality of specified symbols 9.

The display panel 11 displays the software keyboard screen 6 including the deletion key K9. In the simple selection mode, the control portion (the panel control portion 10) replaces the symbol in the selected state in the input display field 61 with the symbol corresponding to the symbol key K1 which is subsequently operated after the operation of the deletion key K9. In this way, it is possible to easily correct the erroneously input symbol.

When the switching key K6 is operated in the simple selection mode, the control portion (the panel control portion 10) returns the mode of the display input device (the operation panel 1) to the normal input mode, and replaces the symbol in the selected state in the input display field 61 with the symbol corresponding to the symbol key K1 which is first operated after the return to the normal input mode. In this way, it is possible to easily correct the erroneously input symbol while cancelling the simple selection mode.

The control portion (the panel control portion 10) displays, on the display panel 11, the correction candidate symbol 8 in the warning state which is different from the normal display. In this way, it is possible to make the user pay attention to the symbol which is likely to be erroneously input. It is also possible to warn the user of the possibility that the symbol is erroneously input.

An image forming apparatus (the multifunctional peripheral 100) according to the embodiment includes the display input device (the operation panel 1) described above. Since it is possible to easily correct the symbol which is erroneously input, it is possible to provide an image forming apparatus to which information such as an address and a name is easily input. It is also possible to provide an easy-to-use image forming apparatus.

Although the embodiment of the present disclosure is described, the scope of the present disclosure is not limited to this embodiment, and various modifications are possible without departing from the spirit of the disclosure.

What is claimed is:

1. A display input device comprising:
a control portion which includes a control circuit;
a display panel which displays, based on control by the control portion, a software keyboard screen including a plurality of symbol keys aligned for inputs of various types of symbols, a switching key for switching between a normal input mode and a simple selection mode and an input display field where a symbol corresponding to the symbol key that is operated is displayed; and
a touch panel which is provided for the display panel so as to detect a position touched by a user,
wherein the control portion
adds, in the normal input mode, each time the symbol key is operated, the symbol corresponding to the symbol key that is operated into the input display field,
recognizes, when the symbol key is operated, as a correction candidate symbol, a symbol corresponding to the symbol key in which a predetermined outer peripheral region outside an inner region in a region of the symbol key is operated,
transfers, when the switching key is operated in the normal input mode, a mode of the display input device to a simple selection mode,
brings, when the mode is transferred to the simple selection mode, into a selected state, any one of the correction candidate symbols among the symbols displayed in the input display field and
replaces, when the symbol in the selected state is corrected, the symbol in the selected state in the input display field with a symbol after being corrected.

2. The display input device according to claim 1,
wherein the display panel displays a direction key in the software keyboard screen, and
when in the simple selection mode, a plurality of the correction candidate symbols are included in the input display field, the control portion brings, when the mode is transferred to the simple selection mode, the correction candidate symbol located at a head into the selected state, and switches the correction candidate symbols which are to be brought into the selected state each time the direction key is operated.

3. The display input device according to claim 1,
wherein the display panel displays a rightward direction key and a leftward direction key in the software keyboard screen, and
when the rightward direction key is operated, the control portion brings, into the selected state, the correction candidate symbol adjacent in a rightward direction to the correction candidate symbol that is brought into the selected state before the operation of the rightward direction key whereas when the leftward direction key is operated, the control portion brings, into the selected state, the correction candidate symbol adjacent in a leftward direction to the correction candidate symbol that is brought into the selected state before the operation of the leftward direction key.

4. The display input device according to claim 1,
wherein in the simple selection mode, the control portion recognizes, as a specified symbol, the symbol corresponding to the symbol key which is operated, and brings, when any one of the symbol keys is operated, into the selected state, any one of the specified symbols among the symbols in the input display field.

5. The display input device according to claim 4,
wherein when in the simple selection mode, a plurality of the specified symbols are included in the input display field, each time the symbol key corresponding to the specified symbol is operated, the control portion switches the specified symbols which are to be brought into the selected state.

6. The display input device according to claim 1,
wherein the display panel displays the software keyboard screen including a deletion key, and
in the simple selection mode, the control portion replaces the symbol in the selected state in the input display field with the symbol corresponding to the symbol key which is subsequently operated after the operation of the deletion key.

7. The display input device according to claim 1,
wherein when the switching key is operated in the simple selection mode, the control portion returns the mode of the display panel to the normal input mode, and replaces the symbol in the selected state in the input display field with the symbol corresponding to the symbol key which is first operated after the return to the normal input mode.

8. The display input device according to claim 1,
wherein the control portion displays, on the display panel, the correction candidate symbol in a warning state which is different from a normal display.

9. The display input device according to claim 1,
wherein the control portion displays, on the display panel, a region setting screen for setting sizes of the inner region and the outer peripheral region, and recognizes, based on the size of each of the regions set in the region selling screen, whether the touched position is the inner region or the outer peripheral region.

10. The display input device according to claim 1,
wherein the control portion switches display states of the switching key depending on whether the mode is the normal input mode or the simple selection mode.

11. An image forming apparatus comprising the display input device according to claim 1.

12. A method of controlling a display input device, the method comprising:
displaying a software keyboard screen including a plurality of symbol keys aligned for inputs of various types of symbols, a switching key for switching between a normal input mode and a simple selection mode and an input display field where a symbol corresponding to the symbol key that is operated is displayed;
detecting a position touched by a user with a touch panel;
adding, in the normal input mode, each time the symbol key is operated, the symbol corresponding to the symbol key that is operated into the input display field;
recognizes, when the symbol key is operated, as a correction candidate symbol, a symbol corresponding to the symbol key in which a predetermined outer peripheral region outside an inner region in a region of the symbol key is operated;
transferring, when the switching key is operated in the normal input mode, a mode of the display input device to a simple selection mode;
bringing, when the mode is transferred to the simple selection mode, into a selected state, any one of the correction candidate symbols among the symbols displayed in the input display field; and
replacing, when the symbol in the selected state is corrected, the symbol in the selected state in the input display field with a symbol after being corrected.
